(19) United States
(12) Patent Application Publication
(10) Pub. No.: US 2004/0198419 A1
(43) Pub. Date: Oct. 7, 2004

(54) Portable electronic device for single hand use

(75) Inventors: Stephen C. Jacobsen, Salt Lake City, UT (US); Fraser M. Smith, Salt Lake City, UT (US)

Correspondence Address: THORPE NORTH & WESTERN, LLP., 8180 SOUTH 700 EAST, SUITE 200, P.O. BOX 1219, SANDY, UT, 84070, US

(73) Assignee: Sarcos Investments LC

(21) Appl. No.: 10/831,942

(22) Filed: Apr. 26, 2004

Related U.S. Application Data
(63) Continuation-in-part of application No. 10/680,563, filed on Oct. 7, 2003.
(60) Provisional application No. 60/416,896, filed on Oct. 7, 2002.

(51) Int. Cl. H04M 1/00

(52) U.S. Cl. 455/550.1

(57) ABSTRACT

A portable electronic device configured for single hand use. The portable electronic device includes a housing, a micro-processor, a display and a keypad. The housing includes an operating surface and an upright hand-held operating position. The micro-processor is disposed within the housing and is coupled to the display and the keypad. The display is positioned on the operating surface and the keypad is positioned on the operating surface above the display with the housing in the upright hand-held operating position.

This application is a continuation-in-part of U.S. Non-Provisional patent application Ser. No. 10/680,563, filed Oct. 7, 2003, which claims benefit of U.S. Provisional Patent Application No. 60/416,896, filed Oct. 7, 2002.

### FIELD OF THE INVENTION

The present invention relates generally to portable electronic devices having displays and, more particularly, the present invention relates to a portable electronic device that optimizes the ability to enter data via a keypad while preserving viewing of a display during data entry.

### BACKGROUND OF THE INVENTION

Portable telephones, such as cordless phones and cellular phones, have become very popular over the past several years. Originally, the electronics that were within a portable phone were bulky and required a large handset to house such electronics. The displays were placed above the keypads used to dial in information using DTMF (dual tone multi frequency). Further, the displays typically only had a single line of text to view. Because of the size and bulk of these original portable phones, the user typically used both hands, one to hold the phone while the other was used to press the keypad. As keys were pressed, the information such as the number being pressed would be displayed on the display to confirm that the user was entering the correct phone number and the single display line was easy to view.

As portable phones have become smaller due to the size reduction of the electronics inside, they have come to fit comfortably in the user's hand and are able to be operated single handedly. While being held in the palm, the user often uses his or her thumb to press the keys. Unfortunately, the current size of even the average portable phone, let alone the smaller ones, has made it awkward to hold the phone and key in information single handedly. For example, when the user is outside, such as in the user's vehicle, it can be awkward to operate the portable phone or cell phone, view the display, and operate the vehicle at the same time. Although it is highly recommended that the user pull to the side of the road and stop the vehicle while answering a call on the portable phone or placing such a call, often the user is not able to take the time to pull to the side and continues to operate the phone while driving.

### SUMMARY OF THE INVENTION

It has been recognized that it would be advantageous to provide a portable electronic device that has a configuration that is more readily manageable for single hand use, and thereby safer, when operated by the user.

The present invention relates to a method and apparatus for providing a portable electronic device configured for single hand use. The portable electronic device includes a housing, a micro-processor, a display and a keypad. The housing includes an operating surface and an upright hand-held operating position. The micro-processor is disposed within the housing and is coupled to the display and the keypad. The display is positioned on the operating surface and the keypad is positioned on the operating surface above the display with the housing in the upright hand-held operating position.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

While the specification concludes with claims particularly pointing out and distinctly claiming that which is regarded as the present invention, the advantages of this invention may be ascertained from the following description of the invention when read in conjunction with the accompanying drawings, in which:

FIG. 1 illustrates a front view of a portable communication device, depicting the portable communication device having a keypad positioned above a display, according to an embodiment of the present invention;

FIG. 1A illustrates a profile side view of the portable communication device;

FIG. 2 illustrates a block diagram of the portable communication device, according to an embodiment of the present invention;

FIG. 3 illustrates a front view of a portable electronic device, according to another embodiment of the present invention; and

FIG. 4 illustrates a block diagram of the portable electronic device depicted in FIG. 3, according to an embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

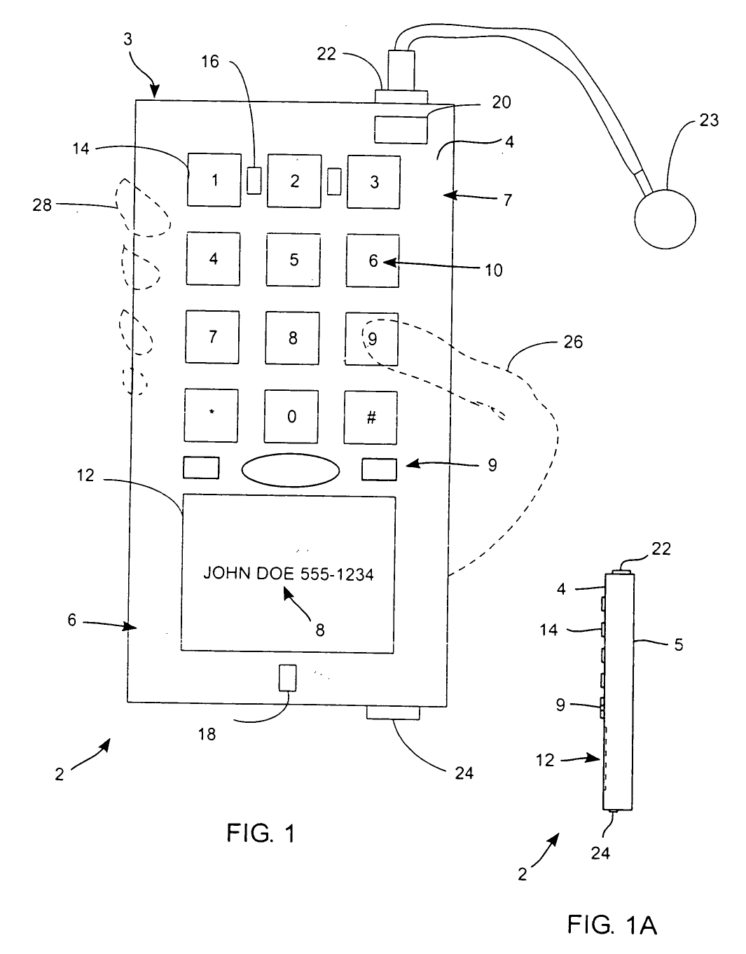

FIGS. 1 and 1A illustrate a portable communication device 2. The communication device 2 is configured for comfortable, single-hand use with a configuration improving the safety and ergonomics while operating the communication device. Such a communication device 2 can be any suitable communication device, such as a portable phone and a mobile phone, or any suitable type of cordless or wireless phone. The communication device can also include communication transmitter devices, such as portable radios, walkie-talkies, personal digital assistant, or any other suitable portable communication device known in the art.

The communication device 2 can include a housing 3 having an operating surface 4 and a back side 5. The operating surface 4 can include a lower portion 6 and an upper portion 7 with a display 12 positioned nearer the lower portion 6 than the upper portion 7 and a keypad 14 positioned above the display 12 nearer the upper portion 7 than the lower portion 6 when the communication device 2 is held in an upright orientation or an upright hand-held operating position. Upright hand-held operating position refers to use of the device 2 in an appropriate orientation, with indicia readable in the appropriate upright orientation. The display 12 can be any suitable display known in the art, such as an LCD display, touch-sensitive display and video display. The display 12 can be configured to display readable indicia 8 in an upright orientation in the form of data and/or images. The upright orientation refers to the normal readable orientation of the indicia 8. The keypad 14 can include keys with an alpha-numeric keypad arrangement as well as function keys 9. Each of the keys of the keypad 14 can include indicia 10 disposed in an upright orientation thereon to identify the specific keys in the keypad 14.

The communication device 2 can also include a speaker 16 and a microphone or transducer 18 positioned near or operable through the operating surface 2. The speaker 16 can be positioned at the upper portion 7 of the operating surface 4 adjacent the keypad 14 close to where a user's ear is when held to the user's head. The transducer 18 can be positioned adjacent the display 12 at the lower portion 6 of the operating surface 4 or at a bottom of the housing 3 to enable the user to speak clearly into the communication device 2.

The communication device 2 further includes an on/off switch 20, an external jack 22, in which an earpiece 23 can connect, and a power connector or jack 24. The communication device 2 typically can be powered either by a direct connection power adapter connected through connector 24 or by rechargeable or disposable batteries disposed in the housing. The adapter would also function to recharge the batteries when in a recharge mode.

With the display 12 positioned below the keypad 14 on the operating surface 4, a user can hold the communication device with all four fingers 28 (shown in outline) around a back side 5 of the housing 3 and with the thumb 26 (shown in outline) comfortably disposed over the keypad 14 to enter data within the communication device 2. The user is therefore able to firmly grip the housing 3 while using an opposing digit 28 or thumb 26 to manipulate the keypad 14 while also keeping a clear view of the display 12 during a data entry sequence. This provides for a safer operating configuration than that of the prior art since the weight of the communication device 2 is held securely in the user's palm and no distractions are created by the user's fingers or thumb crossing over the screen or the device becoming awkward so as to slip out of the user's hand while entering a data entry sequence.

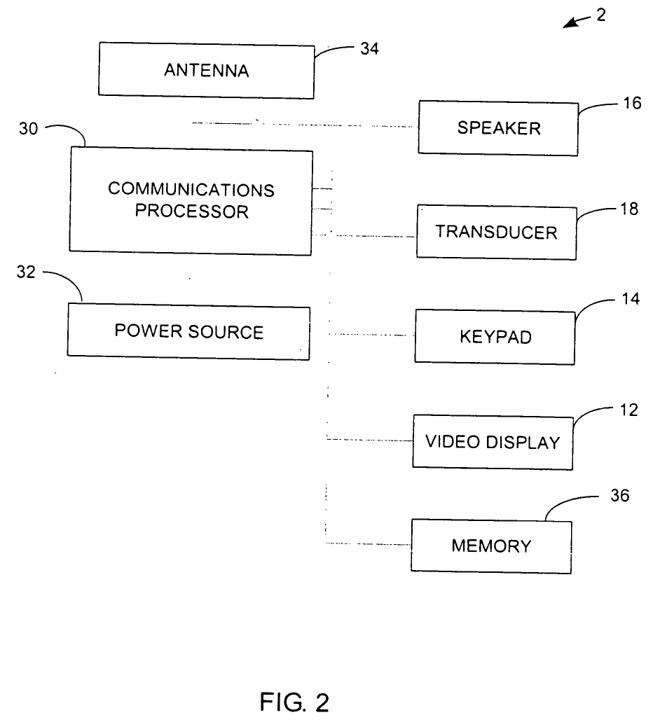

FIG. 2 illustrates a block diagram of some of the operating elements found within the communication device 2. Referring to FIGS. 1 and 2, the communication device 2 includes a communications processor 30, which operates to receive and transmit communication signals through the communication device 2 via an antenna 34. Typically, the entire communication device 2 is powered by some type of power source 32, in most cases this is a rechargeable battery, and may also be powered directly either during a recharge state or just through connection to a power adapter. The communications processor 30 is utilized to operate and control the display 12, a data entry system or the keypad 14, the speaker 16, and the microphone or transducer 18.

The communication device 2 can also include memory 36, which can be controlled by the processor 30, and can be used to store information such as phone numbers, addresses, text messages, and other information desired by the user. The memory 36 can be comprised of flash memory, which needs no additional power to maintain the stored data, or power efficient random access memory (RAM) that requires minimal power, thereby preserving battery life.

The external jack 22 can be provided such that a user can include an earpiece microphone combination to provide hands free listening. The jack 22 bypasses the transducer 18 and speaker 16 when an earpiece/microphone extension is inserted within the jack 22. The user still must operate the communication device 2 within the hand in order to manipulate the keypad 14 and either answer an incoming call or to place an outgoing call, or to enter any other type of data, such as a new telephone number, an address, or place a text message to a desired party. While the jack 22 is connected to an earpiece, the communication device 2 can be programmed to answer automatically, thus allowing hands-free use while driving.

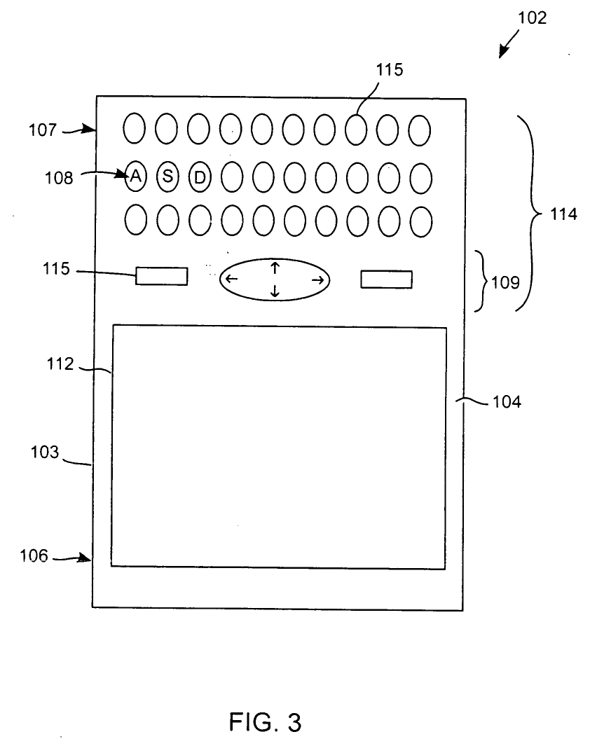

FIG. 3 illustrates another embodiment of a portable electronic device 102 of the present invention. This embodiment is similar to the previous embodiment, except this embodiment does not necessarily include the communications component in the portable electronic device. In this embodiment, the portable electronic device 102 can be any suitable portable device configured to perform computer functions, calculating and/or storing information, i.e., data, images, such as personal digital assistants (“PDA”), calculators, etc. As in the previous embodiment, the portable electronic device 102 can include a housing 103 sized and configured to allow a user to readily operate and hold the device with one hand. Further, the housing can include an operating surface 104 with an upper portion 107 and a lower portion 106. In addition, the operating surface 104 includes the keypad 114 and the display 112 with the keypad 114 positioned on the operating surface 104 above the display 112. In one embodiment, the display 112 can be nearer the lower portion 106 than the upper portion 107 and the keypad 114 can be nearer the upper portion 107 than the lower portion 106. With this arrangement, the keypad 114 is disposed above the display 112 so that the housing 103 can fit within the palm of a user's hand with all four fingers on the back side of the housing and the thumb comfortably positioned over the keypad (See FIG. 1). As such, this arrangement allows the user to firmly hold the portable electronic device 102 while also allowing ready viewability of images and data on the display 112.

The keypad 114 can be a primary key pad with multiple keys 115. In one embodiment the keypad 114 can include function keys 109 including a toggle or curser means. As is well known in the art, function keys 109 are configured to perform and prompt the portable electronic device to perform various functions. In addition, the keypad 114 can include keys representing alphabet digits and/or numeric digits. The keys 115 can include readable indicia 108 or symbols to identify the keys corresponding with the appropriate function keys, alphabet digits and/or numeric digits. Such readable indicia 108 are oriented in an upright orientation with the portable electronic device 102 being held in the upright hand-held operating position. The keys for the alphabet digits can include corresponding indicia of the letters A through Z. The keys for the numeric digits can include corresponding indicia of the numerals 0 through 9.

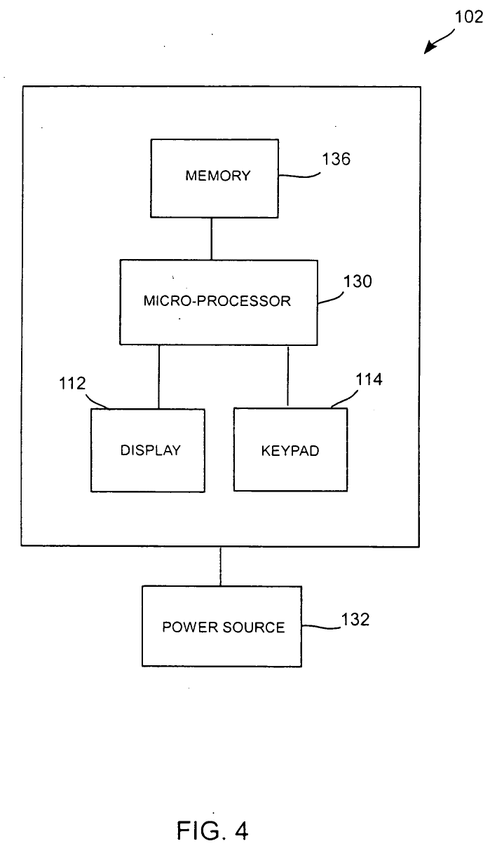

FIG. 4 illustrates a block diagram depicting the primary functional elements of the portable electronic device 102 in FIG. 3. With reference to FIGS. 3 and 4, the portable electronic device 102 can include a micro-processor 130 coupled to memory 136 for storing data, images, etc. Such micro-processor 130 can be coupled to an input and an output, such as the keypad 114 and the display 112, respectively. As such, the micro-processor 130 can be configured to process information, such as performing prompted functions via the keypad 114 for storing information in the memory and retrieving information for viewing on the display 112. In addition, the portable electronic device 102 can include a power source 132 for providing power to each of the micro-processor 130, memory 136, display 112 and keypad 114. As in the previous embodiment, the power source 132 can be a rechargeable battery or powered directly during a recharge state or through a power adapter.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. A portable electronic device configured for single hand use, comprising:
a housing having an operating surface and having an upright hand-held operating position;
a micro-processor, disposed within the housing;
a display, coupled to the micro-processor, positioned on the operating surface; and
a keypad, coupled to the micro-processor, positioned on the operating surface above the display with the housing in the upright hand-held operating position.

2. The device of claim 1, wherein the display is positioned nearer a lower portion of the operating surface than an upper portion of the operating surface and the keypad is positioned nearer an upper portion of the operating surface than the lower portion of the operating surface with the housing in the upright hand-held operating position.

3. The device of claim 1, wherein the housing comprises a back-side operable to be held in the upright hand-held operating position with all four fingers of one hand positioned around the back-side of the housing and with a thumb of the one hand comfortably positioned over the keypad on the operating surface.

4. The device of claim 1, wherein the keypad comprises an alpha-numeric key pad arrangement with readable indicia in an upright orientation with the housing held in the upright hand-held operating position.

5. The device of claim 1, wherein the keypad comprises function keys with readable indicia in an upright orientation with the housing held in the upright hand-held operating position.

6. The device of claim 1, wherein the keypad comprises multiple keys representing numeric digits 0 through 9 with readable indicia of the numeric digits in an upright orientation with the housing held in the upright hand-held operating position.

7. The device of claim 1, wherein the keypad comprises multiple keys representing alphabet digits A through Z with readable indicia of the alphabet digits in an upright orientation with the housing held in the upright hand-held operating position.

8. The device of claim 1, further comprising memory, disposed in the housing and coupled to the micro-processor, operable to store information therein.

9. The device of claim 1, further comprising a battery disposed in the housing operable to provide power to the device.

10. A hand-held portable digitizer device comprising:
a housing having an operating surface and having an upright hand-held operating position;
processing means, within the housing, for processing information;
display means for displaying information responsive to the processing means, the display means positioned nearer a lower portion of the operating surface than an upper portion of the operating surface with the housing disposed in the upright hand-held operating position; and
manual data input means for inputting data information using a thumb and finger of a user's hand, said information to be processed by the processing means and displayed on the display means, the data input means being positioned on the operating surface above the display means.

11. The device of claim 10, wherein the display means is positioned nearer a lower portion of the operating surface than an upper portion of the operating surface and the data input means is positioned nearer an upper portion of the operating surface than the lower portion of the operating surface with the housing in the upright hand-held operating position.

12. The device of claim 10, wherein the housing comprises a back-side operable to be held in the upright hand-held operating position with all four fingers of one hand positioned around the back-side of the housing and with a thumb of the one hand comfortably positioned over the data input means on the operating surface.

13. The device of claim 10, wherein the data input means comprises a primary keypad with multiple keys having readable indicia in an upright orientation with the housing held in the upright hand-held operating position.

14. The device of claim 13, wherein the multiple keys comprise an alpha-numeric keypad arrangement with the readable indicia.

15. The device of claim 13, wherein the multiple keys comprise function keys with the readable indicia.

16. The device of claim 13, wherein the multiple keys comprise keys representing numeric digits 0 through 9 with the readable indicia.

17. The device of claim 13, wherein the multiple keys comprise keys representing alphabet digits A through Z with the readable indicia.

18. The device of claim 10, further comprising means for providing electrical power to the device.

19. The device of claim 10, further comprising memory means, within the housing and coupled to the processing means, for storing information including storing the data information from the data input means.
